(19) United States
(12) Patent Application Publication
(10) Pub. No.: US 2010/0228824 A1
(43) Pub. Date: Sep. 9, 2010

(54) DISTRIBUTED SERVER SELECTION FOR ONLINE COLLABORATIVE COMPUTING SESSIONS

(75) Inventors: Jian Lin, Pleasant Hill, CA (US); Zheng Yuan, San Jose, CA (US); Guomin Zhu, Hangzhou (CN); Weifeng Shen, Hangzhou (CN)

Correspondence Address: CESARI AND MCKENNA, LLP, 88 BLACK FALCON AVENUE, BOSTON, MA, 02210, US

(73) Assignee: Cisco Technology, Inc., San Jose, CA (US)

(21) Appl. No.: 12/399,343

(22) Filed: Mar. 6, 2009

(51) Int. Cl. G06F 15/16; G06F 15/173

(52) U.S. Cl. 709/204; 709/226

(57) ABSTRACT

In one embodiment, an attendee device detects interest to join an online collaborative computing session, and determines a list of distributed servers for the online collaborative computing session in a computer network. The attendee device may then measure a round trip time (RTT) to each distributed server from the attendee device, such that the attendee device may select a distributed server for the online collaborative computing session based on the RTT. Accordingly, the attendee device many then join the online collaborative computing session through the selected distributed server (e.g., which may cascade communication for the session from a hosting distributed server).

### TECHNICAL FIELD

The present disclosure relates generally to computer networks, and, more particularly, to online collaborative computing sessions.

### BACKGROUND

Online collaborative computing sessions, such as interactive conferences (e.g., web conferences/meetings), may be supported by a computer network having one or more servers distributing content between participating client computers. In particular, one or more participants, e.g., hosts and/or attendees, may join a session from their client computers through an access point to the servers, such as a web page. Subsequently, data/content originated by the host/presenter is then distributed to the attendees of the session.

Often, it is desirable to physically distribute servers in order to distribute the load on any one server. In this scenario, a central or “hosting” server initiates the distribution of content (e.g., as received from a source/presenter device). The distributed servers may receive the content from the hosting server over a dedicated network, and forward the content to locally interested users (attendee devices). Typically, the users are statically assigned to a predefined distributed server (e.g., based on location), regardless of whether this predefined server is the optimal server. Also, the hosting server is generally required to send the same copy of the data to each participant, thus resulting in increased traffic through the computer network that consumes network resources.

### BRIEF DESCRIPTION OF THE DRAWINGS

The advantages of the invention may be better understood by referring to the following description in conjunction with the accompanying drawings in which like reference numerals indicate identically or functionally similar elements, of which:

FIG. 1 illustrates an example computer network;

FIG. 2 illustrates an example device/node;

FIG. 3 illustrates an example server arrangement;

FIGS. 4-5 illustrate an example server distribution network; and

FIG. 6 illustrates an example procedure for selecting a distributed server for an online collaborative computing session.

### DESCRIPTION OF EXAMPLE EMBODIMENTS

### Overview

According to some embodiments of the disclosure, an attendee device detects interest to join an online collaborative computing session, and determines a list of distributed servers for the online collaborative computing session in a computer network. The attendee device may then measure a round trip time (RTT) to each distributed server from the attendee device, such that the attendee device may select a distributed server for the online collaborative computing session based on the RTT. Accordingly, the attendee device many then join the online collaborative computing session through the selected distributed server (e.g., which may cascade communication for the session from a hosting distributed server).

### Description

Architecture for Collaborative Computing Sessions

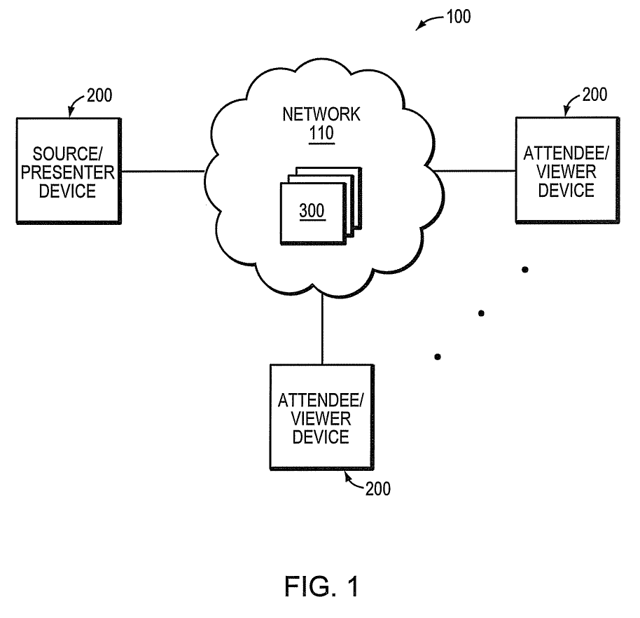

FIG. 1 is a schematic block diagram of an example computer network 100 illustratively comprising nodes/devices, such as one or more participant devices 200 and one or more interaction servers 300 interconnected by links/network 110 as shown and as described further herein. For instance, participant devices, as described below, may be a personal computer (PC) or one or more peripheral devices, such as phones, pagers, etc. Those skilled in the art will understand that any number of nodes, devices, links, etc. may be used in the computer network, and that the view shown herein is for simplicity.

In this environment, a number of participants may interact in an online, interactive, or collaborative setting. Such a setting can be for a meeting, training or education, support, or any other event that may require a number of participants to work together, interact, collaborate, or otherwise participate, such as web conferences, online meetings, etc. As used herein, the phrase “collaborative computing session” may be used to describe these settings/events, particularly where a number of participant computers/devices collaborate in an established session, as may be appreciated by those skilled in the art. Also, as used herein, a “session” describes a generally lasting communication between one or more participant devices 200 through the interaction server 300. Those skilled in the art will understand that the session may be implemented/established using protocols and services provided by various layers (e.g., application, session, and/or transport layers) of a network protocol stack according to the well-known OSI model. Conversely, a “meeting” describes a personal layer of communication overlaid upon the session where participants/users communicate with each other.

Moreover, while the terms “session” and “meeting” may generally be used interchangeably herein to denote a collaboration of people or devices, particular instances of their use may denote a particular distinction (e.g., a session may start with attendees joining/connecting to the servers, while a meeting may not start until a host/presenter joins the session), as may be understood by those skilled in the art. In other words, a collaboration session generally comprises a plurality of devices or “participant devices,” of which “attendee devices” are configured to view/receive content submitted or “shared” by “presenter devices.” In some instances, the attendee devices are capable of modifying the content shared by the presenter device.

In particular, each participant (e.g., hosts/presenters and/or attendees) may operate a participant device 200. Each participant device 200 may comprise an electronic device with capability for visual and/or auditory presentation. Thus, a participant device 200 can be, for example, a desktop personal computer (PC), a laptop computer, a workstation, a personal digital assistant (PDA), a wireless telephone, a smart phone, an Internet television, and the like. Each participant device 200 supports communication by a respective participant, in the form of suitable input device (e.g., keyboard, mouse, stylus, keypad, etc.) and output device (e.g., monitor, display, speech, voice, or other device supporting the presentation of audible/visual information). Each participant device may be interconnected with a suitable communications network 110 such as, for example, the Internet, and may appear as a client computer thereon.

In one embodiment, each participant device 200 may operate under the control of a suitable operating system (OS) (e.g., WINDOWS, UNIX, etc.) to run software applications (e.g., in the form of code modules) which may be installed, received, or downloaded. At least some of these software applications may support specific functions, such as, for example, functions related to the online, interactive meeting (a collaborative computing session), such as conventional web browser programs that allow convenient access and navigation of the Internet (e.g., the World Wide Web).

The collaborative computing session of the various participants may be supported by an interaction server 300 which may be maintained or operated by one or more of the participants and/or a third-party service provider. The interaction server 300 may be a computer system that is connected to network 110, and which may comprise and appear as one or more server computers thereon. Interaction server 300 may store information (e.g., content) and application modules which can be provided to the participant devices 200. In some embodiments, these application modules are downloadable to the participant devices 200 and may support various functions that may be required for an interactive meeting or collaborative effort among the participants. The participant devices 200 and the interaction server 300 may interact in a client/server architecture, which may provide high performance and security for a multi-participant collaborative environment.

Network 110 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” Web servers maintain websites, each comprising one or more web pages at which information is made available for viewing and audio/hearing. Each website or web page may be supported by documents formatted in any suitable conventional markup language (e.g., HTML or XML). Information may be communicated from a web server to a client using a suitable protocol, such as, for example, Hypertext Transfer Protocol (HTTP) or File Transfer Protocol (FTP).

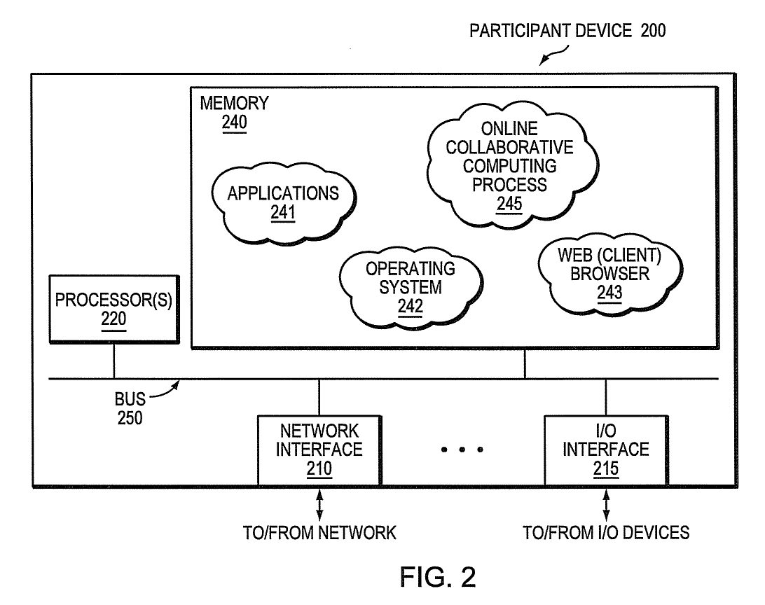

FIG. 2 illustrates a schematic block diagram of an example participant device 200 that may be advantageously used with one or more embodiments described herein, e.g., for collaborative computing. Illustratively, device 200 may be implemented or incorporated in any suitable computer such as, for example, a personal computer (PC), laptop, workstation, personal digital assistant (PDA), smart phone, mainframe, file server, workstation, or other suitable data processing facility supported by storage (either internal, e.g., electronic memory, or external, e.g., magnetic/optical disk), and operating under the control of any suitable OS.

In particular, the device 200 comprises one or more network interfaces 210, one or more input/output (I/O) interfaces 215, one or more processors 220, and a memory 240 interconnected by a system bus 250. The network interfaces 210 contain the mechanical, electrical, and signaling circuitry for communicating data over physical/wireless links coupled to the network 110. The network interface(s) may be configured to transmit and/or receive data using a variety of different communication protocols suitable for the network. Also, 1/0 interfaces 215 contain the mechanical, electrical, and signaling circuitry for communicating with one or more user interface devices, such as a mouse, keyboard, monitor/screen, etc. (not explicitly shown).

The memory 240 comprises a plurality of storage locations that are addressable by the processor(s) 220 and the network interfaces 210 for storing software programs associated with the embodiments described herein. A portion of the memory may (though need not) be arranged as a cache (not shown) configured to store one or more data structures and/or code modules associated with embodiments described herein. The processor(s) 220 may comprise necessary elements or logic adapted to execute the software programs and manipulate the data structures. An operating system 242, portions of which are typically resident in memory 240 and executed by the processor(s), functionally organizes the device by, inter alia, invoking operations in support of software processes and/or services executing on the device (e.g., for collaborative computing sessions as used herein). In particular, these software processes and/or services may comprise one or more applications 241 (e.g., web browser 243) as understood by those skilled in the art, and, in particular, an online collaborative computing process (or “collaboration process”) 245, as described herein. It will be apparent to those skilled in the art that other types of processors and memory, including various computer-readable media, may be used to store and execute program instructions pertaining to the inventive technique described herein.

The online collaborative computing process 245 may contain computer executable instructions executed by the processors 220 to generally perform functions to manage or control various processes or aspects during the course of an online meeting or collaborative computing session in which the participant (user) may interact with other users. For instance, an activity manager may manage meeting-related actions (e.g., starting a session, ending a session, locking a session, etc.), manage participant-related actions (e.g., designating a participant as a session host, assigning a participant the presenter privileges, expelling a participant, establishing participant privileges, etc.), manage session-related actions (e.g., starting a sharing session, closing a sharing session, setting privileges within that sharing session, etc.), and support an interface with the user or participant, and provide a container for embedding one or more application code modules.

Also, a communications component of process 245 may support communication between system 200 and an outside network 110 (e.g., the Internet), such as through network interfaces 210. The communications component thus allows data and information to be exchanged with or retrieved from other systems or facilities (e.g., participant devices 200 or interaction server 300), for example, during an online meeting or other collaborative computing session. In particular, the communications component may provide a communication platform for any one or more process instances of process 245. For instance, the activity manager may rely on the communications component to establish and maintain the client connection to the interaction server 300 on which the activity session is hosted, specifically, as described below. Any application code modules (not shown) may also use the established client connection to provide real-time data that is sent and received by each participant.

Various functionality for supporting a collaborative computing session, such as an online meeting, may be provided by the one or more application code modules, generally described herein as being components of the online collaborative computing process 245. These application code modules may be stored/maintained (e.g., by a cache), and may support, for example, basic communication framework, file sharing (e.g., for text, images, video, audio), user authentication, meeting scheduling, address book, files and folders, invoices, billing, scheduling, telephone or video conferencing, authentication, database management, word processing, application sharing, accounting, etc. For example, code modules may comprise (not specifically shown) a text-based chat module, a polling module, a video module, a voice over Internet Protocol (VOIP) module, a question-answer (QA) module, a file transfer module, a presentation module, an application/desktop view/share module, and an Internet telephony module.

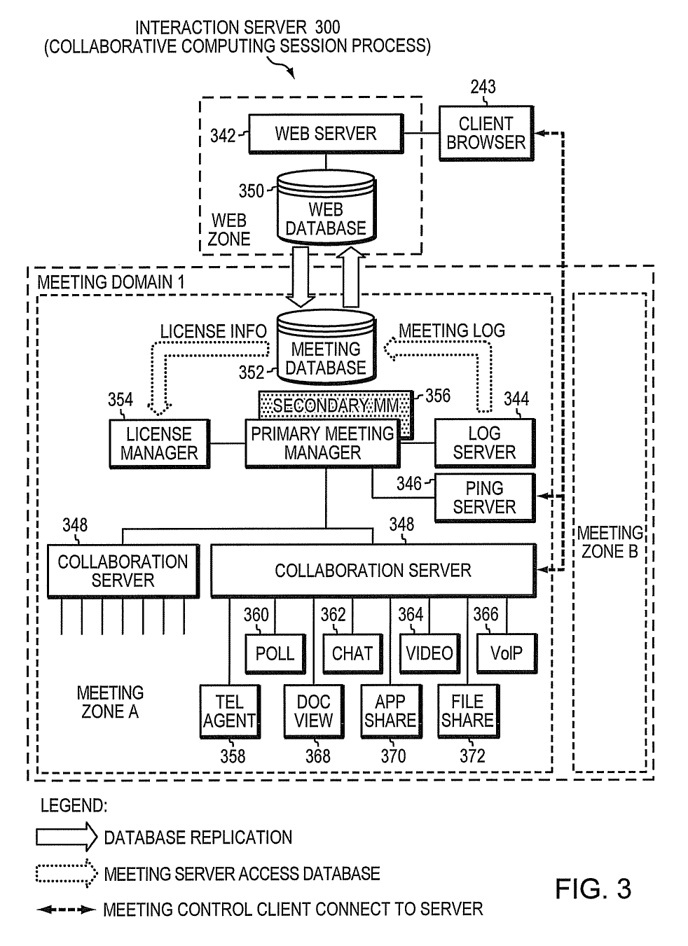

FIG. 3 illustrates an example implementation for a computer system that may operate as interaction server 300 according to one or more embodiments described herein. Illustratively, in the computer system environment as shown, a number of server computers and databases may be in communication to provide for collaborative meeting or computing. As such, an interaction server 300 and its various components may be referred to as a collaborative computing process 300. Notably, while the illustrative embodiment described below shows a collection of servers (e.g., localized and/or distributed), a single server may also operate to perform the functions described herein (e.g., collaborative computing process 300). Thus, “interaction server 300” may comprise, either as a single server or as a collection of servers, one or more memories, one or more processors, one or more network interfaces (e.g., adapted to communicate traffic for a collaborative computing session and also traffic on a communication channel other than the collaborative computing session), etc., as may be appreciated by those skilled in the art.

In particular, referring to the environment shown in FIG. 3, a number of processing facilities, including, for example, one or more of a web server 342, a log server 344, a ping server 346, a collaboration server 348, license manager 354, primary and secondary meeting managers 356, application servers (e.g. telephone agent 358, poll 360, chat 362, video 364, voice over IP 366, document view 368, application share 370, and file share 372) may be integrated with a number of data storage facilities, such as, for example, a web database 350 and a meeting database 352 to implement a system for collaborative meetings over the Internet (e.g., for collaborative computing session “process” 300). As depicted, the processing and database facilities of this environment (“process” 300) may be divided into a web zone and one or more meeting zones for interaction with one or more client browsers (which may operate on respective participant devices 200).

A web zone may comprise one or more server machines that share a common web database 350. In the web zone, web server 342 may have a unique IP address (which may be associated with a particular website) and may respond to, e.g., Hyper-Text Transport Protocol (HTTP) requests coming to that IP address from client browser 243. Web server 342 serves or supports web pages, while web database 350 may contain static information for the website including site specific data, web pages, and user data.

Illustratively, a meeting zone is a collection of servers and databases that help perform synchronous activity of an online collaborative meeting. In a meeting zone, the meeting managers 356 may be servers which communicate with other servers in the meeting zone (e.g., collaboration server 348, log server 344, ping server 346, etc.) to keep track of the online meetings in progress in the meeting zone. Meeting managers 356 may log meeting information into meeting database 352. Ping server 346 works with meeting managers 356 to determine a collaboration server 348 that is most suitable for hosting a particular meeting; it may act as a load balancer for the meeting service. Collaboration servers 348 may handle all real time control and communication during an online collaborative meeting. The application servers (e.g., servers 358 through 372) may support specific features that may be available as part of an online collaborative meeting, such as, for example, telephony, polling, chatting, video, voice over IP, document review, application sharing, and file sharing (e.g., “sub-sessions”). Also, license manager 354 may keep track of and enforce licensing conditions and charges for the meeting. Further, the log server 344 may keep track of meeting logs, and meeting database 352 may maintain at least a portion of the transient data required to conduct and keep track of online meetings. This data may include, for example, site and user information that would be required to establish and conduct a meeting.

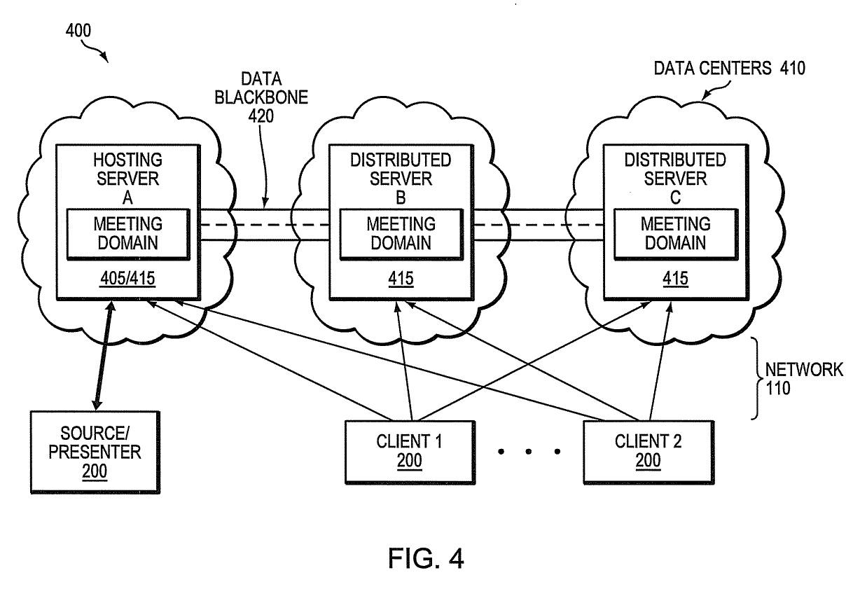

As noted above, it may be desirable to physically distribute collaboration servers 300 in order to distribute the load on any one server. In this scenario, a central or “hosting” server initiates the distribution of content (e.g., as received from a source/presenter device). The distributed servers may receive the content from the hosting server over a dedicated network, and forward the content to locally interested users (attendee devices). FIG. 4 illustrates an example distributed server network 400 comprising a plurality of data centers 410, each having one or more distributed servers 415, denoted as Servers A-C. (In one embodiment, the distributed servers may operate as on-premise servers within a customer network.) Illustratively, the distributed servers operate on a private network within the computer network, communicating over a dedicated data backbone 420 between each server. Client/attendee devices 200 may be in communication with the distributed servers 415 via network 110 (shown as arrows for use below), including a source/presenter device 200, and two illustrative client devices (“1” and “2”) 200.

Generally, each online collaborative computing session may be hosted by a particular distributed server 405, which may either be a distributed server located nearest to a source/presenter device 200, or a centralized collaboration server (e.g., 300), from which all other distributed servers merely distribute session data. In particular, each distributed server 415 maintains information for other meetings running in the other distributed servers/locations (data centers). The hosting server 405 (a “top domain”) may communicate the session data to the distributed servers (“global domains”) through collaboration server/broker 348 to transmit the data, and may utilize the meeting zone manager 356 to coordinate the session for load balancing (logins, user access, etc.). While each server 415/405 may comprise the full suite of services shown in collaboration server 300 above, the hosting server 405 executes the full suite, while the other distributed servers execute only (or only have) the collaboration server/broker 348 and meeting zone manager 356 (shown as “Meeting Domains”).

Typically, the users in such a distributed server network are statically assigned to a predefined distributed server (e.g., based on location), regardless of whether this predefined server is the optimal server. For example, attendee device “Client 2” may be statically configured to use Server C, regardless of the performance through Server C. Also, the hosting server 405 (e.g., Server A) is generally required to send the same copy of the data to each participant, thus resulting in increased traffic through the computer network (e.g., over data backbone 420) that consumes network resources. In particular, remote access service for users in a remote location is generally associated with lower performance, since the remote access data generally has to travel to a hosting server in a centralized data center 410, and then back to the remote location, even if the two participant devices in the remote access session are more closely located to each other than to the centralized data center.

Efficiently Selecting Distributed Servers

According to one or more embodiments of the disclosure, an attendee device detects interest to join an online collaborative computing session, and determines a list of distributed servers for the online collaborative computing session in a computer network. The attendee device may then measure a round trip time (RTT) to each distributed server from the attendee device, such that the attendee device may select a distributed server for the online collaborative computing session based on the RTT. Accordingly, the attendee device many then join the online collaborative computing session through the selected distributed server (e.g., which may cascade communication for the session from a hosting distributed server).

Illustratively, the techniques described herein may be performed by hardware, software, and/or firmware, such as in accordance with online collaborative computing session (“collaboration”) process 245, which may contain computer executable instructions executed by the processor 220 to perform functions relating to the novel techniques described herein. In particular, collaboration process 245 (e.g., in conjunction with that of the servers 300 where applicable) may be used to select a distributed server (e.g., an optimally located server) for online collaborative computing sessions, such as for hosted sessions and on-premise sessions that allow a meeting to be distributed to servers at different locations, as described below.

Operationally, an attendee device (e.g., “client 2”) may detect interest to join or start a particular online collaborative computing session based on receiving a request to join (or start) the session or meeting. For example, a user at the attendee device may open an application designated to execute the session, and by attempting to login or otherwise access the session (e.g., through a web browser 243 accessing a web page designated for the session) the attendee device may determine in which session the user is interested. The attendee device may then determine a list of distributed servers 415 for the online collaborative computing session in the computer network, such as by receiving the list of available meeting server locations from either a central server or a locally configured server. For instance, in the event the attendee device “client 2” accesses the session from a local distributed server C (e.g., manually or dynamically configured), then that particular server may return a list of other participating distributed servers (e.g., A and B) within the network for the session of interest, as noted above. (Alternatively, the list of available servers may be predetermined at the attendee device, such as a statically configured list that may be periodically updated.)

Once the list of available distributed servers is obtained, the attendee device may measure a network latency or round trip time (RTT) to each distributed server in a variety of manners. For example, in an illustrative embodiment, the attendee device may measure the RTT based on the time it takes for each distributed server to respond to a join request sent from the attendee device. In other words, once the distributed servers are known, the attendee device may transmit (send) a join request to each server to initiate the session, and the RTT may be based on the response time to the join request. Alternatively, an RTT measurement may be made separately from a join request, such as in the form of an echo request message sent to each distributed server. For instance, various echo request protocols are known in the art, such as ICMP “Ping” messages, or other application-specific techniques to ping a device. As such, the RTT may be based on a response time to the echo request for each distributed server. From the perspective of FIG. 4, Client 2 may determine the RTT through network 110 to reach its local distributed server C, an intermediate distributed server B, and a hosting server A.

Those skilled in the art will understand how measurements of RTT are accomplished, such as through transmit/receive timestamping, etc. In addition, other parameters may also be measured, such as measuring Quality of Service (QoS) parameters. For example, typical QoS parameters may include delay, jitter, available bandwidth, packet loss, etc. The QoS parameters may be used in conjunction with the RTT (or separately) to make server decisions, as described below.

Notably, according to one or more embodiments described herein, the RTT includes not only the RTT to reach each respective distributed server, but the actual total time to reach the hosting distributed server (e.g., server A) through the channel used for the session data transmission. In other words, by measuring the roundtrip time to a distributed server, it may be advantageous to add the time for that distributed server to receive data from (and transmit data to) the hosting server, e.g., through the dedicated data backbone 420. One technique that may be used to determine this total RTT is to forward the RTT measurement packets (join messages, pings, etc.) all the way to the hosting server (A). Alternatively, each distributed server may actively measure the RTT (the latency between the server locations) in real time, and may inform the requesting attendee device of this additional time (e.g., as separate information to be added by the attendee device).

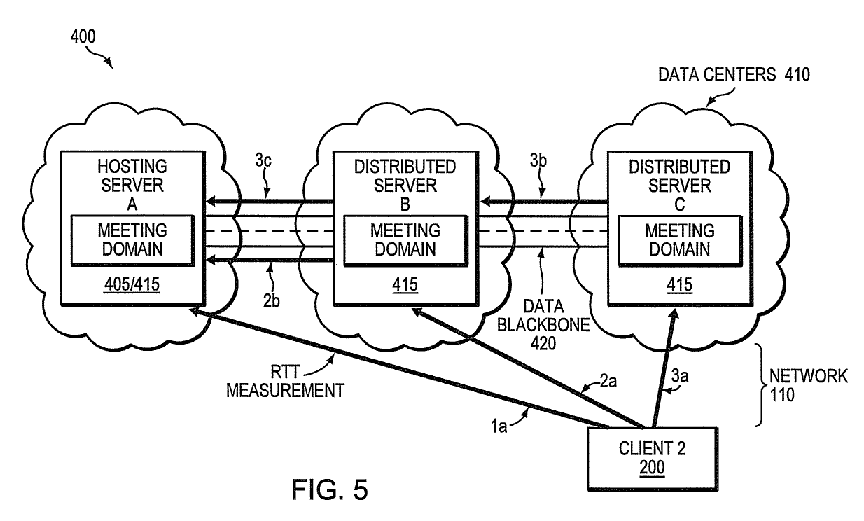

FIG. 5 illustrates an example RTT measurement in accordance with the embodiment mentioned above, particularly showing RTT measurements for attendee device “client 2.” For instance, Client 2 may illustratively send three join messages based on there being three available distributed servers (including the hosting server A). As such, a first RTT measurement (in no particular order) may traverse network 110 to and from the hosting server A (shown by “1”). Also, a second RTT measurement (“2”) may traverse the network 110 to an intermediate distributed server B, then through the data backbone 420 to the hosting server A, and returned. Finally, a third RTT measurement (“3”) may traverse the network 110 to an distributed server C, then through the data backbone 420 to intermediate server B, and at last to the hosting server A, and returned.

(Note that while measuring the RTT is described in relation or in response to an interest to join/start a session, the act of measuring may be performed independently of either determining interest in or joining an online collaborative computing session. For instance, a data center RTT map may be maintained by an attendee device using an application 241 separate from the collaboration process 245. This application (not specifically shown) may measure the RTT to each data center/server at predefined time intervals. In this manner, the RTT information may be available for different applications, as well.)

Upon determining the RTT to each available distributed server (e.g., by receiving the start or join meeting/session request response from each server/data center), an attendee device may select a particular distributed server (data center/location) for the online collaborative computing session (e.g., meeting) based on the RTT. For instance, while the algorithm/logic and parameters for this selection are configurable for each session type, location, etc., an illustrative selection may be based simply on which distributed server has the shortest RTT (e.g., to just the distributed server, or through to the hosting server, as mentioned above).

On the other hand, more complex decision algorithms may be configured, such as selecting a distributed server based on a weighted selection. For example, a weighted selection may be based on the RTT to reach each particular distributed server and to the hosting distributed server versus the RTT to reach the hosting distributed server. In other words, the attendee device may select the physically closest server/data center based on the RTT, unless the RTT between the closest server and the hosting server is too large. One example technique that may be used is to configure a weighted value (“WV”) threshold for selection, based on the following formula:

$$W V = \frac{R T T \cdot total - R T T \cdot host}{R T T \cdot host - R T T \cdot local} \qquad Eq . 1$$

where “RTT.total” is the RTT from the attendee device to the local distributed server and through to the hosting server (e.g., 3a+3b+3c), “RTT.host” is the RTT directly to the hosting server (e.g., la), and “RTT.local” is the RTT to the local distributed server (e.g., 3a). For example, assume that the measured RTT values are: 3a=20 ms, 3b=50 ms, 3c=40 ms, and 1a=50 ms. According to Eq. 1, then, 3a+3b+3c=20+50+40, or 110 ms, and (110−50)/(50−20)=2. If the threshold for WV is set for less than (or equal to) 2, then the attendee device may select the hosting server A directly, while if the threshold is set for greater than (or equal to) 2, then the attendee device may select the local distributed server (notably, where “local” implies a particular server, and is not based on location.) In this manner, the larger values are for RTT.host, the more likely the attendee device is to choose one of the distributed servers. (Those skilled in the art will appreciate that the threshold value of 2 is merely a representative example, and is not meant to limit the scope of the embodiments described herein.)

According to one or more embodiments described herein, once a particular distributed server is selected (e.g., server C), then the attendee device may join the online collaborative computing session through the selected distributed server, thus receiving data for the session from the selected distributed server. Notably, the selected distributed server may “cascade” the session data from the hosting server A, thereby reducing the network traffic between the hosting server and the selected distributed server. In other words, a single copy of the data is transmitted from the hosting server to the selected distributed server, and that selected distributed server may propagate the single copy to each attendee device (for which the selected server is responsible). The attendee devices may maintain a connection with the hosting server, simply not receiving any data directly from the hosting server (i.e., only receiving copies from the distributed server). The data backbone 420 is thus relieved of the redundant traffic from the hosting server to the distributed tributed servers. (In the event that the attendee device is the initiating source/presenter device, the selection process may still comprise selecting a “closest” distributed server based on RTT, and then that selected server becomes the hosting server for all other attendee devices desiring to join the session.)

Moreover, in one embodiment herein, the attendee device may store the selected distributed server in order to use the same (previously selected) distributed server for a subsequent online collaborative computing session (e.g., for the same network). For instance, the attendee device may detect interest in another session, and may (though need not) re-measure the RTT only to the previously selected distributed server in order to confirm whether the re-measured RTT has significantly changed from the previous RTT. If the re-measured RTT is minimally different (a configurable comparison) from the previous RTT, then the attendee device may simply re-use the previously selected distributed server for the session. If, on the other hand, the re-measured RTT is more than minimally different from the previous RTT, then the attendee device may measure RTTs to all other distributed servers for use with re-selecting a distributed server for the subsequent online collaborative computing session. (Moreover, the stored RTTs may be maintained, e.g., collected and stored at a centralized database, such that user experience may be monitored to guide future client-server location selection and optimization, including the placement of future distributed servers.)

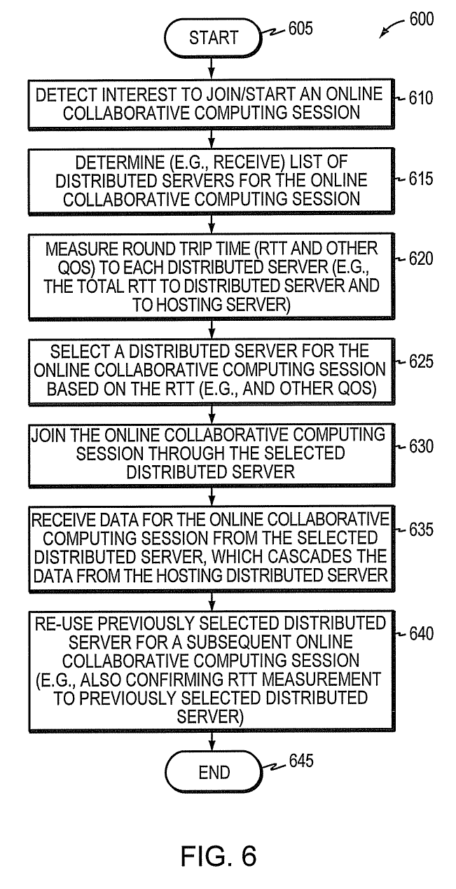

FIG. 6 illustrates a simplified example procedure for selecting distributed servers for online collaborative computing sessions in accordance with one or more embodiments described herein. The procedure 600 starts at step 605, and continues to step 610, where an attendee device (e.g., collaboration process 245) detects an interest to join (or start) an online collaborative computing session, such as through a join request from a user, as mentioned above. As such (in one embodiment), the attendee device in step 615 determines (e.g., receives) a list of available distributed servers for the online collaborative computing session, and in a manner described above, measures RTT (and other QoS parameters) to each distributed server in step 625. For example, as noted, the RTT to the distributed server and to the hosting server may be measured or otherwise obtained, accordingly.

Based on the RTT (e.g., and other QoS), the attendee device may select a particular distributed server for the online collaborative computing session based in step 625, and may thus join the online collaborative computing session in step 630 through the selected distributed server, as described above. Once the session has begun (e.g., a meeting, a file transfer, etc.), the attendee device may receive data for the online collaborative computing session from the selected distributed server in step 635, notably, which may cascade the data from the hosting distributed server, as discussed herein.

Also, according to one or more embodiments described herein, in step 640 the attendee device may re-use a previously selected distributed server for a subsequent online collaborative computing session. For example, the attendee device may first confirm the RTT measurement to the previously selected distributed server, and if there are any unacceptable discrepancies, may elect to re-measure RTT to all other distributed servers in order to re-select an optimal server. The procedure 600 ends in step 645, notably with the inherent option to continue to receive data in step 635, or to perform various failover and/or backup operations based on re-selecting servers and/or re-measuring RTTs, as mentioned above (though not specifically shown as a step in procedure 600).

Advantageously, the novel techniques described herein provide efficient distributed server selection for online collaborative computing sessions in a computer network. By selecting a distributed server based on at least RTT, the novel techniques allow an attendee device to achieve better session performance through reduced latency. In particular, the techniques described above decrease data traffic flow within the network through server cascading, particularly for large online collaborative computing sessions, and allow for a simple addition of remote distributed servers to reach global customers in remote locations. Also, the dynamic aspects of one or more embodiments described herein alleviate the need for cumbersome and inefficient manual configuration.

Additionally, using the techniques above with multiple distributed servers, failover and overflow of session services may be performed transparently to the user. In particular, the global distributed server arrangement may also include “on-premise” servers that operate in a customer's data center. For instance, for a customer attending a meeting from inside a firewall, the techniques above will select an on-premise location based on the RTT in the same manner. If a customer has multiple on-premise systems in different data centers, each server may function as a backup to the other servers. That is, backup servers may be given a lower priority as compared to primary servers, such that when a primary server is available, the attendee device selects the primary. However, when the primary server fails, then a backup server may be selected in its place. The same RTT logic described above may be used to select a backup server, whether that server is a dedicated backup, or simply an un-selected distributed server. Also, since customers can have meeting services in different locations, each service location used as a primary by local users can also be used by users of another location if the service in the other location is down (failed) or has reached full capacity.

While there have been shown and described illustrative embodiments that provide efficient distributed server selection for online collaborative computing sessions in a computer network, it is to be understood that various other adaptations and modifications may be made within the spirit and scope of the present invention. For example, the embodiments have been shown and described herein for use with online collaborative computing sessions that imply meetings. However, the embodiments of the invention in their broader sense are not so limited, and may, in fact, be used with any data distribution from a hosting server to a plurality of distributed servers. For example, an online collaborative computing session may equally imply static content sharing, application/file downloading, streaming or downloaded playback of media, remote device access (e.g., PC sharing), web servers (page hosting), etc.

In addition, according to one or more embodiments described herein, an online collaborative computing session may comprise one or more “sub-sessions,” such as a different sub-session for various components of the session itself. As mentioned above, these sub-sessions may comprise voice, data, video, chat, file transfer, etc. In this particular instance, distributed servers may be selected based on sub-session participation, where each sub-session has a corresponding distributed server. (Note that each subsession should have at least one distributed server, but that distributed server may also be a distributed server for another sub-session.) This may be useful for a variety of reasons, including more specific QoS parameter measurement (e.g., one server performs better for voice versus another server performing better for data, etc.).

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
detecting interest for an attendee device to join an online collaborative computing session;
determining a list of distributed servers for the online collaborative computing session in a computer network;
measuring a round trip time (RTT) to each distributed server from the attendee device;
selecting a distributed server for the online collaborative computing session based on the RTT; and
joining the online collaborative computing session by the attendee device through the selected distributed server.

2. The method as in claim 1, wherein detecting interest comprises:
receiving a request to join the online collaborative computing session.

3. The method as in claim 1, wherein determining the list comprises:
receiving the list from a particular one of the distributed servers.

4. The method as in claim 1, wherein measuring comprises:
sending a join request to each distributed server; and
basing the RTT on a response time to the join request for each distributed server.

5. The method as in claim 1, wherein measuring comprises:
sending an echo request message to each distributed server; and
basing the RTT on a response time to the echo request for each distributed server.

6. The method as in claim 1, wherein measuring comprises:
determining the RTT for each distributed server based on a time to reach each particular distributed server in addition to the time for that particular distributed server to reach a hosting distributed server that hosts the online collaborative computing session.

7. The method as in claim 1, wherein measuring is performed independently of at least one of determining interest and joining the online collaborative computing session.

8. The method as in claim 1, further comprising:
measuring Quality of Service (QoS) parameters in addition to the RTT, the QoS parameters selected from a group consisting of: delay, jitter, available bandwidth, and packet loss.

9. The method as in claim 1, wherein selecting comprises:
selecting a distributed server having a shortest RTT.

10. The method as in claim 1, wherein selecting comprises:
selecting a distributed server based on a weighted selection, the weighted selection based on the RTT to reach each particular distributed server in addition to the time for that particular distributed server to reach a hosting distributed server that hosts the online collaborative computing session versus the RTT to reach the hosting distributed server.

11. The method as in claim 1, further comprising:
receiving data for the online collaborative computing session from the selected distributed server, the selected distributed server cascading the online collaborative computing session data from a hosting distributed server that hosts the online collaborative computing session.

12. The method as in claim 1, further comprising:
using a previously selected distributed server for a subsequent online collaborative computing session.

13. The method as in claim 12, further comprising:
re-measuring the RTT only to the previously selected distributed server for a subsequent online collaborative computing session;
using the previously selected distributed server in response to the re-measured RTT being minimally different from a previous RTT for the previously selected distributed server; and
measuring RTTs to all other distributed servers in response to the re-measured RTT being more than minimally different from the previous RTT for use with reselecting a distributed server for the subsequent online collaborative computing session.

14. The method as in claim 1, wherein the distributed servers operate on a private network within the computer network.

15. The method as in claim 1, wherein the distributed servers operate as on-premise servers within a customer network of the attendee device.

16. An apparatus, comprising:
one or more network interfaces adapted to transmit and receive data on a computer network;
a processor coupled to the network interfaces and adapted to execute one or more processes; and
a memory configured to store a collaboration process executable by the processor, the collaboration process when executed operable to:
detect interest to join an online collaborative computing session;
determine a list of distributed servers for the online collaborative computing session in a computer network;
measure a round trip time (RTT) to each distributed server;
select a distributed server for the online collaborative computing session based on the RTT; and
join the online collaborative computing session through the selected distributed server.

17. The apparatus as in claim 16, wherein the collaboration process when executed is further operable to:
receive the list from a particular one of the distributed servers.

18. The apparatus as in claim 16, wherein the collaboration process when executed is further operable to:
measure the RTT based on one of either a time to respond to a join request or a time to respond to an echo request.

19. The apparatus as in claim 16, wherein the collaboration process when executed is further operable to:
determine the RTT for each distributed server based on a time to reach each particular distributed server in addition to the time for that particular distributed server to reach a hosting distributed server that hosts the online collaborative computing session.

20. The apparatus as in claim 16, wherein the collaboration process when executed is further operable to:
select a distributed server based on one of either a shortest RTT or a weighted selection, the weighted selection based on the RTT to reach each particular distributed server in addition to the time for that particular distributed server to reach a hosting distributed server that hosts the online collaborative computing session versus the RTT to reach the hosting distributed server.

21. A tangible computer-readable media having software encoded thereon, the software when executed on a device operable to:
detect interest to join an online collaborative computing session;
determine a list of distributed servers for the online collaborative computing session in a computer network;
measure a round trip time (RTT) to each distributed server;
select a distributed server for the online collaborative computing session based on the RTT; and
join the online collaborative computing session through the selected distributed server.
